(19) United States
(12) Patent Application Publication
(10) Pub. No.: US 2024/0162734 A1
(43) Pub. Date: May 16, 2024

(54) AN ELECTRIC BATTERY JUNCTION ARRANGEMENT AND AN ELECTRICAL SYSTEM

(71) Applicant: Scania CV AB, Södertälje (SE)

(72) Inventors: Michael VALLINDER, Mölnbo (SE); David RAYMAND, Uppsala (SE); Johan HAGBERG, Årsta (SE); Daniel EKENBERG, Tumba (SE)

(73) Assignee: Scania CV AB, Södertälje (SE)

(21) Appl. No.: 18/279,910

(22) PCT Filed: Mar. 8, 2022
(86) PCT No.: PCT/SE2022/050219

§ 371 Date: Sep. 1, 2023

(30) Foreign Application Priority Data
Mar. 10, 2021 (SE) 2150274-5

(51) Int. Cl. H02J 7/00

(52) U.S. Cl. CPC H02J 7/0063; H02J 7/0013; H02J 7/0031

(57) ABSTRACT

Provided is an electric battery junction arrangement for connecting an electric battery arrangement to one or more electrical loads. The electric battery arrangement comprising two or more electric battery cells and a control circuit comprising: (i) a first control circuit branch connectable to a positive side of the battery arrangement and a positive side of an electrical load; (ii) a second control circuit branch connectable to a negative side of the battery arrangement and a negative side of an electrical load; (iii) at least one semiconductor apparatus provided between and configured to control electric current between the battery arrangement and the loads; and (iv) a switching apparatus comprising at least one mechanical switch arranged in an electrical circuit connection between the first and the second control circuit branch for electrically connecting and disconnecting the first and the second control circuit branch to and from each other.

### TECHNICAL AREA

The present application relates to an electric battery junction arrangement for connecting an electric battery arrangement to one or more electrical loads. The application also relates to an electrical system comprising an electric battery junction arrangement of the above-mentioned sort and comprising the electric battery arrangement.

### BACKGROUND OF INVENTION

An electric battery cell can be seen as a container chemically storing energy. The electric battery cells may come in various forms and shapes. The electric battery cells may be connected in series and in parallel, into an electric battery arrangement, which may be called an electric battery pack, in order to attain the desired voltage and energy capacity. A conventional electric battery pack may be the complete enclosure or unit that delivers electric power to a product or equipment, for example an electric vehicle, such as a battery electric vehicle or a hybrid electric vehicle.

In general, a conventional electric battery pack includes or contains electric battery cells, a control or management system, which may be called a battery management system (BMS) and may for example be implemented partly as software, and often also a cooling and/or heating system. Conventionally, the electric battery arrangement or electric battery pack may be arranged in modules to attained serviceable units. In general, each electric battery cell may include a cell fuse for short-circuit protection.

Since many types of battery solutions for electrically driven vehicles operate with high voltages, safety requirements and legal demands have been developed for ensuring a safe handling for operators and service personnel in that it must be ascertained that the battery pack is properly disconnected when the vehicle is not operating. A conventional solution is shown in FIG. 1 where mechanical contactors 10 are placed between a battery arrangement 12 and electrical energy consumers 14 of the vehicle. This will ensure a complete disconnection between the battery pack and the consumers.

A drawback with this solution is that the durability of the contactors is limited. In that regard, there is often a problem with providing sufficient cooling of the contactors, which limits the working life and performance of them. Furthermore, the contactors are often rather bulky and take up space that could be used better. Another drawback is that there is a risk of permanent closing of the contactors due to welding between the contact surfaces if there is a high current through the contactors when they are to be opened. The potential may also be a problem since the contactors cannot be closed if the there is a high potential. For such situations, a pull-up circuit is needed in addition in order to match the potentials on either side of the contactor before closing. This adds up to more components requiring more space.

There is thus room for improvement in this technical area.

### BRIEF DESCRIPTION OF INVENTION

The aim of the present application is to remedy the drawbacks of the state of the art solutions. This aim is obtained by the features of the independent patent claims. Preferable embodiments of the application form the subject of the dependent patent claims.

According to one aspect, an electric battery junction arrangement is provided for connecting an electric battery arrangement to one or more electrical loads. The electric battery arrangement may comprise two or more electric battery cells. The electric battery junction arrangement may comprise a control circuit, which control circuit comprises a first control circuit branch connectable to a positive side of the battery arrangement and connectable to a positive side of an electrical load, a second control circuit branch connectable to a negative side of the battery arrangement and connectable to a negative side of an electrical load.

The control circuit may comprise a semiconductor apparatus provided between the battery arrangement and the loads and configured to control electric current between the battery arrangement and the loads, such as allowing a flow of current, interrupting the flow of current and controlling the amount of current flowing, in particular current from the battery arrangement to the consumers.

The control circuit may further comprise a switching apparatus, which switching apparatus comprises at least one mechanical switch arranged in an electrical circuit connection between the first and the second control circuit branch for electrically connecting and disconnecting the first and the second control circuit branch to and from each other.

With this solution, semiconductors are used for controlling the flow of current between the battery arrangement and the consumers, which provides advantages in relation to more conventional contactors and switches. The current flowing through the semiconductors has lower and more manageable losses compared to for instance passively cooled contactors due to that the semiconductors are built for cooling and are thereby better cooled, which allows for higher performances. A solution with semiconductors also takes up less space than a mechanical contactor.

A solution with semiconductors provides in the majority of cases a safe switching off of a battery junction according to the application, but to ensure that no potential may be prevailing over the battery arrangement, the switching apparatus will provide a connection between the positive side and the negative side of the control circuit when closing the electrical connection circuit.

According to one aspect, the semiconductor apparatus may be disposed in the first control circuit branch between the battery arrangement and the electrical circuit connection. As an alternative, the semiconductor apparatus may disposed in the second control circuit branch between the battery arrangement and the electrical circuit connection. As a further alternative, the semiconductor apparatus may comprise a first semiconductor apparatus disposed in the first control circuit branch between the battery arrangement and the electrical circuit connection as well as a second semiconductor apparatus disposed in the second control circuit branch between the battery arrangement and the electrical circuit connection. There is thus a choice of how the flow of current is controlled by the semiconductors while still maintaining a high degree of safety with the switching apparatus.

According to a further aspect, the first and/or the second semiconductor apparatus may comprise at least two transistors connected back-to-back. In this way, current can flow and be controlled both ways through the semiconductor apparatus. In this regard, a plurality of transistors may be connected in parallel in order to handle the current levels that can occur.

Preferably, the switching apparatus may be an electrically operable switching apparatus. In this regard, the switching apparatus may be controllable in response to a control signal from a controller.

When the mechanical switch of the switching apparatus is in a closed position, it is configured to short-circuit the electric battery arrangement. On the other hand, during operation of the electric battery arrangement, the mechanical switch of the switching apparatus is configured to be in an open position.

According to a further aspect, the control circuit may further comprise an overload current breaker provided between the battery arrangement and the electrical circuit connection between the first and the second control circuit branch. This ensures that the battery arrangement is not damaged should the semiconductor devices mal-function. In this regard, the overload current breaker may comprise any of thermal breaker, mechanical breaker, electronic breaker or combinations thereof.

According to a further aspect of the application, an electrical system may be provided, comprising an electric battery junction arrangement according to the application, wherein the electrical system may comprise an electric battery arrangement.

Further, a vehicle may be provided, comprising one or more of the group of an electric battery junction arrangement according to the application and an electrical system according to the application.

These and other aspects of, and advantages with, the present invention will become apparent from the following detailed description of the invention and from the accompanying drawings.

### BRIEF DESCRIPTION OF DRAWINGS

In the following detailed description of the invention, reference will be made to the accompanying drawings, of which

FIG. 1 is a schematic view of a conventional electric battery junction arrangement;

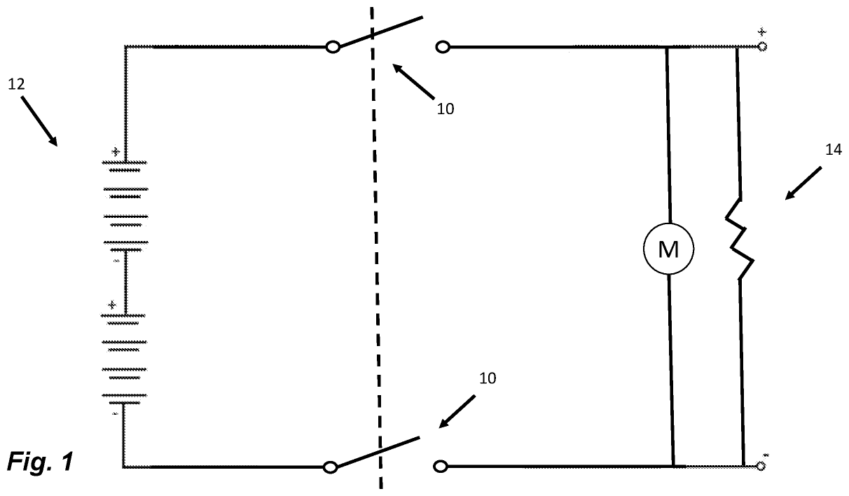

FIG. 2 is a schematic diagram illustrating a first embodiment of an electric battery junction arrangement and electrical system according to the application;

FIG. 3 is a schematic diagram illustrating a variant of the electric battery junction arrangement and electrical system according of FIG. 1;

FIG. 4 is a schematic diagram illustrating another variant of the electric battery junction arrangement and electrical system according FIG. 1; and

FIG. 5 is a schematic side view of a vehicle provided with the electric battery junction arrangement and electrical system according to the application.

### DETAILED DESCRIPTION OF THE INVENTION

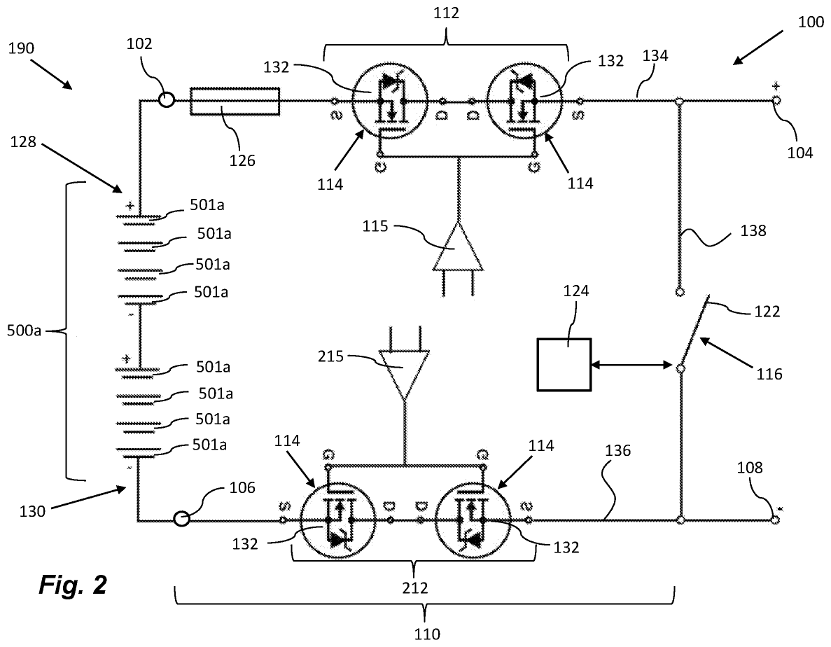

An embodiment of an electric battery junction arrangement 100 is schematically shown in FIG. 2. The arrangement 100 is arranged to electrically connect an electric battery arrangement 500a to one or more electrical loads. As seen in FIG. 2, the electric battery arrangement 500a may comprise two or more electric battery cells 501a, for instance arranged in a module. Each electric battery cell 501a may be a rechargeable electric battery cell, for example, a lead-acid battery cell, a Li-ion battery cell, or a NiMH battery cell, but are not limited thereto. The electric battery cells 501a may be electrically connected in series and/or in parallel into the electric battery arrangement 500a in order to attain the desired voltage and energy capacity.

The electric battery arrangement 500a may deliver electric power to one or more loads or equipment, for example included in a vehicle. The arrangement 500a may for example be configured for propulsion of a vehicle 700, such as an electric vehicle, EV. In this respect, the electric battery cells 501a and/or the electrical battery arrangement 500a may be configured for high voltage, such as voltages from above 60 V and up to voltages above 1500 V, depending on the requirements on the specific vehicle in which the electric battery arrangement 500a is to be used.

The electric battery junction arrangement 100 comprises a first input 102 or connection point and a second input 106 or connection point for connection to the electric battery arrangement 500a. As seen in FIG. 2, the first input 102 connects to a positive side 128 of the battery arrangement 500a while the second input connects to a negative side 130 of the battery arrangement 500a.

Further, the electric battery junction arrangement 100 comprises a first output 104 or connection point and a second output 108 or connection point arranged to connect to electrical loads or consumers of the vehicle. In this regard, the first output 104 is electrically connected to the first input 102 in a first circuit branch 134 via suitable electrical conductors and/or wiring, forming the positive side of the consumers, whereas the second output 108 is electrically connected to the second input 106 in a second circuit branch 136 formed by suitable electrical conductors and/or wiring, forming the negative side of the consumers. It is to be understood that depending on the direction of the electric current, for example if the electric battery arrangement 500a provides electric power to a load or if the electric battery arrangement 500a is charged, the first and second inputs 102, 106 may sometimes act as outputs while the first and second outputs 104, 108 may act as inputs.

With reference to FIG. 2, the electric battery junction arrangement 100 comprises a control circuit 110. The control circuit 110 is provided for controlling the electric power transfer, or the electric current, to/from the electric battery arrangement 500a. The control circuit 110 comprises a first semiconductor apparatus 112 arranged in the first circuit branch 134 and is configured to control the electric current between the first input 102 and output 104. In this regard, the first semiconductor apparatus 112 may comprise one or more semiconductor devices 114. The first semiconductor apparatus 112 may be controlled by a controller 115 for controlling current through the first semiconductor apparatus 112.

The control of the electric current between the first input 102 and the first output 104 performed by the first semiconductor apparatus 112 may comprise one or more of the group of: electric current regulation; interrupting the electric current; and passing the electric current.

Further, as seen in FIG. 2, the control circuit 110 may comprise a second semiconductor apparatus 212 arranged in the second circuit branch 136 and is configured to control the electric current between the second input 106 and output 108. In this regard, the second semiconductor apparatus 212 may have the same configuration as the first semiconductor apparatus and may comprise one or more semiconductor devices 114. The second semiconductor apparatus may also be controlled by a controller 215 for controlling current through the second semiconductor apparatus 212.

The semiconductor device 114 may comprise any one of the group of:
a field effect transistor, FET;
a metal oxide semiconductor field effect transistor, MOSFET;
an N-channel metal oxide semiconductor, NMOS;
a P-channel metal oxide semiconductor, PMOS;
a junction gate field effect transistor, JFET;
an insulated gate bipolar transistor, IGBT; and
a bipolar junction transistor, BJT.

Moreover, the first semiconductor apparatus 112 may comprise at least two transistors 132 connected back-to-back and/or the second semiconductor apparatus 212 may comprise at least two transistors 132 connected back-to-back. Generally, a plurality of transistors may be connected in parallel in order to handle the current levels through the semiconductor apparatus 112.

According to the present application, the control circuit 110 comprises a switching apparatus 116. The switching apparatus 116 is electrically connected between the first and the second circuit branch and thus in parallel with the battery pack with an electrical circuit connection 138. The switching apparatus 116 comprises one or more mechanical switches or contactors 122, such as for example a mechanical contactor that can be opened or closed. The mechanical switch or contactor 122 may be an electrically operable and may be controllable in response to a control signal from a controller 124.

With reference to FIG. 2, the control circuit 110 may include a first overload current breaker 126. The first semiconductor apparatus 112 may be connected to one of the first input 102 and the first output 104 via the first overload current breaker 126. In the shown embodiment, the first semiconductor apparatus 112 is connected to the first input 102 via the overload current breaker 126. It is however to be understood that the overload current breaker 126 may be arranged in other locations in the control circuit 110, providing the same functionality of breaking the circuit 110 should a current overload occur, such as a short circuit. The overload current breaker 126 may be configured trip or blow if the first semiconductor apparatus 112 fails and will thus render the electric battery arrangement 500a safe. In some embodiments, the overload current breaker 22 may comprise any of thermal breaker or fuse, mechanical breaker, electronic breaker or combinations thereof. However, other types of fuses are possible for the first overload current breaker 126.

The application is intended to function as follows. When the vehicle 700 is activated, the controller 124 will activate the mechanical switch or contactor 122 of the switching apparatus 116 to open, breaking the connection of the electric circuit connection 138 between the first and the second circuit branch 134, 136. When the vehicle is operating, consumers such as electric motors and the like will cause current to flow through the circuit from the battery packs over the semiconductor apparatuses 112, 212. The semiconductor apparatuses 112, 212 may then be used to control the current levels to the consumers with the help of the controllers 115, 215. The switching apparatus 116 will further also keep the mechanical switch or contactor 122 open when the battery arrangement 500a is connected to a charging source.

When the vehicle is put in an inactivated state, the controllers 115, 215 “deactivate” the semiconductor devices 114 of the semiconductor apparatuses 112, 212 so that no current can flow through the semiconductor apparatuses 112, 212, isolating the battery arrangement 500a from the consumer side. In order to ascertain that no potential remains between the connections 104, 108 on the consumer side that could be harmful or dangerous, the mechanical switch or contactor 122 of the switching device 116 is closed by the controller 124, connecting the first circuit branch 134 with the second circuit branch with the electric circuit connection 138, short circuiting the system. This ensures safe handling of the battery arrangement 500a. If any of the semiconductor devices 114 of the semiconductor apparatuses 112, 212 should mal-function so that they are open to allow current through, the short circuit of the system will cause the current overload breaker 126 to blow or trip, also ensuring safe handling of the battery arrangement 500a.

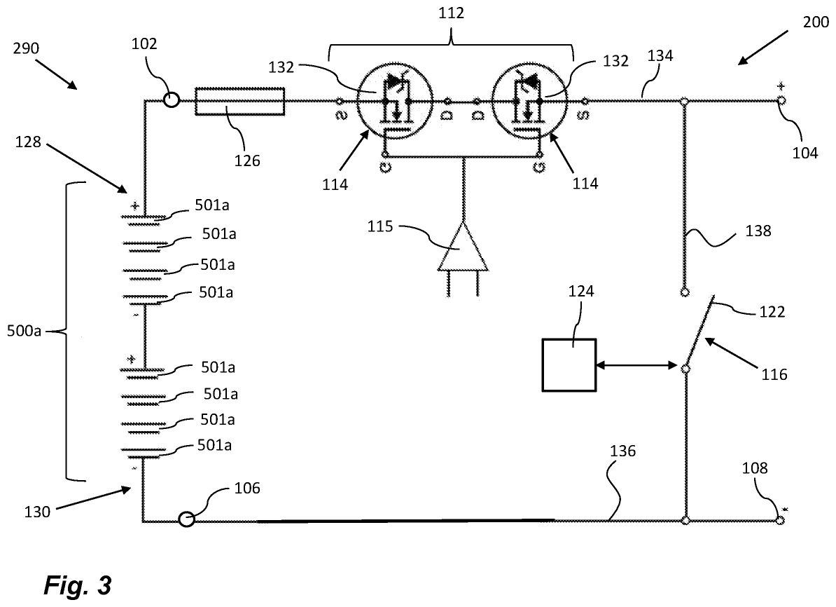

FIG. 3 shows an alternative of the application. In this embodiment, a semiconductor apparatus 112 is arranged only on the positive side 128 of the control circuit, i.e. the first circuit branch 134. For the rest, the setup of the other components of the system is the same as the first described embodiment, having the same reference numerals. Since they have been described in detail above, they will not be discussed further in detail.

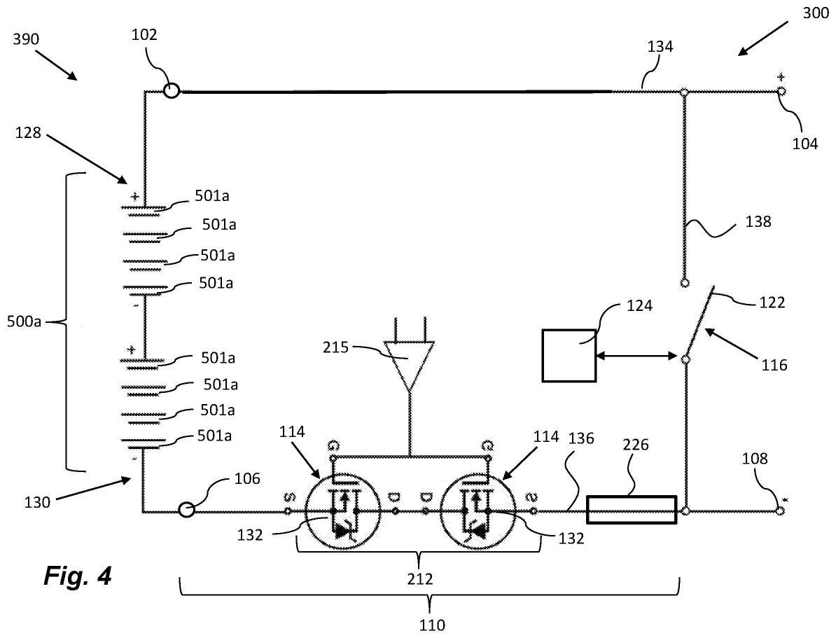

Instead of providing a semiconductor apparatus on the positive side 128, FIG. 4 shows a further variant in which a second semiconductor apparatus 212 instead may be arranged only on the negative side 130 of the control circuit 110, i.e. the second circuit branch 136. Again, for the rest, the setup of the other components of the system is the same as the first described embodiment, apart from the overload circuit breaker 126 that may be placed in the second circuit connection 138. As seen in FIG. 4, a second overload circuit breaker 226 is here placed between the second semiconductor apparatus 212 and the electric circuit connection 138, although providing the same function as described above.

With reference to FIGS. 2 to 4, also embodiments of an electrical system 190, 290, 390 are schematically illustrated. The electrical system 190, 290, 390 includes an electric battery junction arrangement 100, 200, 300 according to any one of the embodiments disclosed above. The electrical system 190, 290, 390 includes the electric battery arrangement 500a. With reference to FIGS. 2 to 4, one or more of the controllers 115, 215, 124 disclosed above may be included in, or connected, to one and the same control system. Further. As seen in FIGS. 2 to 4, the semiconductor apparatuses 112, 212 comprise two transistors connected back-to-back. An advantage is that an efficient control of the electric current in both directions is provided. It is to be understood that a plurality of transistors may be connected in parallel in order to handle the current levels that can occur.

As disclosed above, the connections mentioned above may be defined as electrical connections. In the context of this disclosure, “connected” is to be understood as directly connected or indirectly connected. In the context of this disclosure, “electrically connected” is to be understood as directly electrically connected or indirectly electrically connected. For example, when two items are described as connected, or electrically connected, to one another, it is to be understood that these two items may be directly connected to one another or indirectly connected to one another.

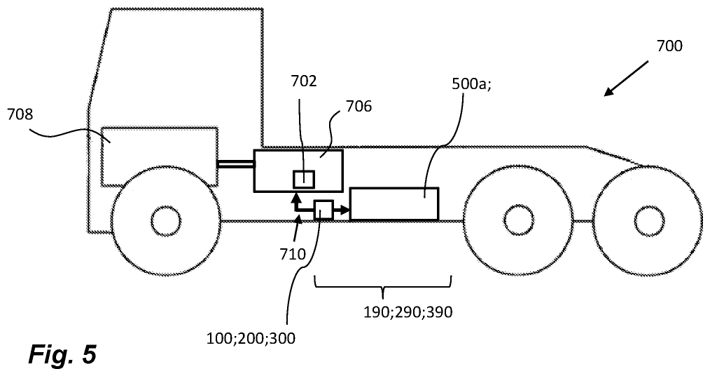

FIG. 5 schematically shows a vehicle 700 comprising the electric battery junction arrangement 100, 200, 300 and the electrical system 190, 290, 390 according to the application. The vehicle 700 may for example be a bus, a truck, a heavy truck or a car. In this regard, the vehicle 700 may have a powertrain 706 comprising a combustion engine assisted by one or more electrical motors 708, such as an electric vehicle, EV, for example a hybrid vehicle or a hybrid electric vehicle, HEV, or a battery electric vehicle, BEV. The power train 706 may be electrically connected via a vehicle electrical system 710 to the electrical system 190, 290, 390 with the battery arrangement 500a via the battery junction arrangement 100, 200, 300.

It is to be understood that the embodiments described above and mentioned in the drawings are to be regarded only as non-limiting examples of the application and that it may be modified in many ways within the scope of the patent claims.

1. An electric battery junction arrangement for connecting an electric battery arrangement to one or more electrical loads, the electric battery arrangement comprising two or more electric battery cells, wherein the electric battery junction arrangement comprises a control circuit; which control circuit comprises:
a first control circuit branch connectable to a positive side of the battery arrangement and connectable to a positive side of an electrical load;
a second control circuit branch connectable to a negative side of the battery arrangement and connectable to a negative side of an electrical load;
at least one semiconductor apparatus provided between the battery arrangement and the loads and configured to control electric current between the battery arrangement and the loads; and
a switching apparatus, which switching apparatus comprises at least one mechanical switch arranged in an electrical circuit connection between the first and the second control circuit branch, for electrically connecting and disconnecting the first and the second control circuit branch to and from each other.

2. An electric battery junction arrangement according to claim 1, wherein the semiconductor apparatus is disposed in the first control circuit branch between the battery arrangement and the electrical circuit connection.

3. An electric battery junction arrangement according to claim 1, wherein the semiconductor apparatus is disposed in the second control circuit branch between the battery arrangement and the electrical circuit connection.

4. An electric battery junction arrangement according to claim 1, wherein the semiconductor apparatus comprises a first semiconductor apparatus disposed in the first control circuit branch between the battery arrangement and the electrical circuit connection and a second semiconductor apparatus disposed in the second control circuit branch between the battery arrangement and the electrical circuit connection.

5. An electric battery junction arrangement according to claim 1, wherein the first and/or the second semiconductor apparatus comprises at least two transistors connected back-to-back.

6. An electric battery junction arrangement according to claim 1, wherein the switching apparatus is an electrically operable switching apparatus.

7. An electric battery junction arrangement according to claim 6, wherein the switching apparatus is controllable in response to a control signal from a controller.

8. An electric battery junction arrangement according to claim 1, wherein the switching apparatus configured to short-circuit the electric battery arrangement by keeping the at least one mechanical switch in a closed position.

9. An electric battery junction arrangement according to claim 1, wherein the switching apparatus is configured to keep the at least one mechanical switch in an open position during operation of the electric battery arrangement.

10. An electric battery junction arrangement according to claim 1, wherein the control circuit further comprises at least one overload current breaker provided between the battery arrangement and the electrical circuit connection between the first and the second control circuit branch.

11. An electric battery junction arrangement according to claim 10, wherein said overload current breaker comprises any of thermal breaker, mechanical breaker, electronic breaker or combinations thereof.

12. An electrical system comprising an electric battery junction arrangement for connecting an electric battery arrangement to one or more electrical loads, the electric battery arrangement comprising two or more electric battery cells, wherein the electric battery junction arrangement comprises a control circuit; which control circuit comprises:
a first control circuit branch connectable to a positive side of the battery arrangement and connectable to a positive side of an electrical load;
a second control circuit branch connectable to a negative side of the battery arrangement and connectable to a negative side of an electrical load;
at least one semiconductor apparatus provided between the battery arrangement and the loads and configured to control electric current between the battery arrangement and the loads; and
a switching apparatus, which switching apparatus comprises at least one mechanical switch arranged in an electrical circuit connection between the first and the second control circuit branch for electrically connecting and disconnecting the first and the second control circuit branch to and from each other.

13. A vehicle comprising an electric battery junction arrangement
for connecting an electric battery arrangement to one or more electrical loads, the electric battery arrangement comprising two or more electric battery cells, wherein the electric battery junction arrangement comprises a control circuit; which control circuit comprises:
a first control circuit branch connectable to a positive side of the battery arrangement and connectable to a positive side of an electrical load;
a second control circuit branch connectable to a negative side of the battery arrangement and connectable to a negative side of an electrical load;
at least one semiconductor apparatus provided between the battery arrangement and the loads and configured to control electric current between the battery arrangement and the loads; and
a switching apparatus, which switching apparatus comprises at least one mechanical switch arranged in an electrical circuit connection between the first and the second control circuit branch for electrically connecting and disconnecting the first and the second control circuit branch to and from each other.
